(19) United States
(12) Patent Application Publication
(10) Pub. No.: US 2009/0287782 A1
(43) Pub. Date: Nov. 19, 2009

(54) Interactive Multimedia Timeline

(76) Inventor: Daniel Brian Odess, Coral Gables, FL (US)

Correspondence Address: Brian D. Laubscher, 2776 S. Arlington Mill Dr., Suite 807, Arlington, VA, 22206, US

(21) Appl. No.: 12/153,084

(22) Filed: May 14, 2008

(51) Int. Cl. G06F 15/16; G06F 17/00

(52) U.S. Cl. 709/206

(57) ABSTRACT

A method and system for allowing a plurality of users to collaboratively interact via a dynamic timeline that presents a plurality of events in an interactive multimedia format. The method and system allows a user to define a computer network group by setting access parameters, add additional individual user to a network group, create a timeline to receive and display a plurality of events, display a timeline to all of the users of the network group, place an event on the timeline in a chronologically ordered manner, allow the individual user to interact with a plurality of events on the timeline, and to send a notification of the individual user timeline interaction to all of the users of the network group.

### BACKGROUND OF THE INVENTION

### Field of the Invention

The present invention relates to software generally, and more specifically to an interactive timeline method and system.

### BRIEF SUMMARY OF THE INVENTION

A method and computer-implemented system for allowing a plurality of users to collaboratively interact via a dynamic timeline that presents a plurality of events in a multimedia format. Multiple users associated in computer network groups add, view, and respond to various events on a dynamic timeline thereby to interact with each other and assess the progress of events in a project.

### BRIEF DESCRIPTION OF THE DRAWINGS

Other objects and advantages of the invention will become apparent from a is study of the following specification when viewed in the light of the accompanying drawings, in which:

FIG. 1 is a flow diagram of the overall steps of the dynamic timeline system.

FIG. 2 is a continuation of FIG. 1 of the overall steps of the dynamic timeline system, diagramming user interactions and output.

FIG. 3 is a flow diagram of selecting and displaying a specific dynamic timeline from a plurality of timelines.

FIG. 4 is a flow diagram of adding a multimedia file to a timeline.

FIG. 5 is a flow diagram of modifying a multimedia file.

FIG. 6 is a flow diagram of adding a digital mark to a multimedia file.

FIG. 7 is a flow diagram of selecting an existing message for a user to interact with.

FIG. 8 is a flow diagram of defining a type of message and entering text for the message.

FIG. 9 is a flow diagram of sending a user message.

FIG. 10 is a flow diagram of time and date stamping a message and sending an electronic notification.

FIG. 11 is a flow diagram of displaying, editing, and deleting the message types that are available to the users of the system.

FIG. 12 is a flow diagram of assigning a time and date stamp to a multimedia file, defining the file properties, assigning multimedia types, and concurrently storing this file information and multimedia file in the system.

FIG. 13 is a flow diagram of displaying, editing, and deleting the multimedia types that are available to the users of the system.

### DETAILED DESCRIPTION OF THE INVENTION

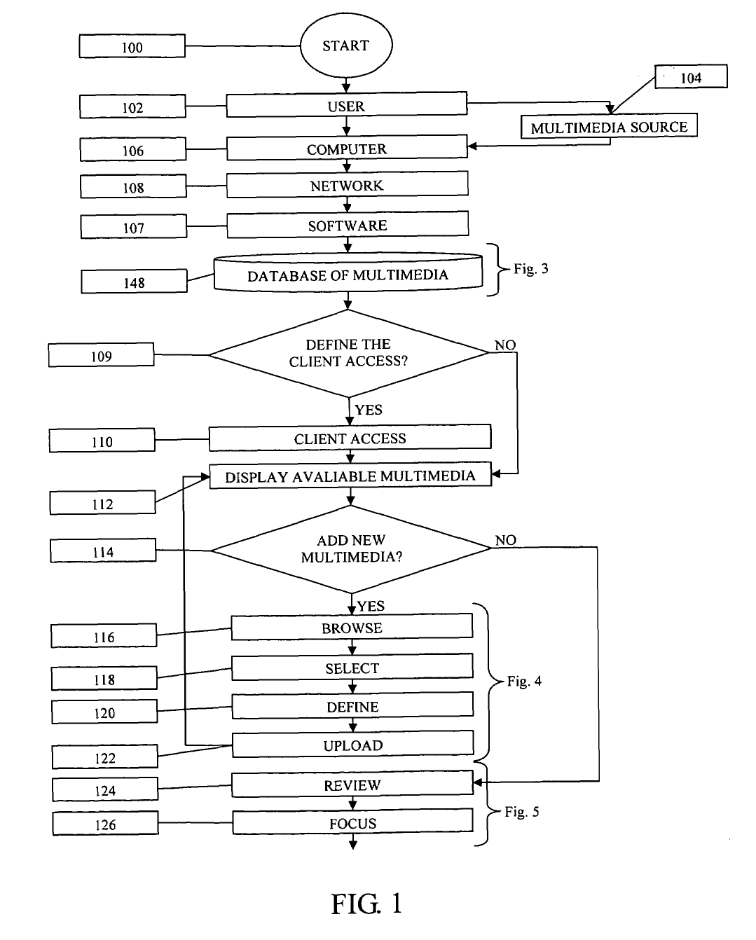

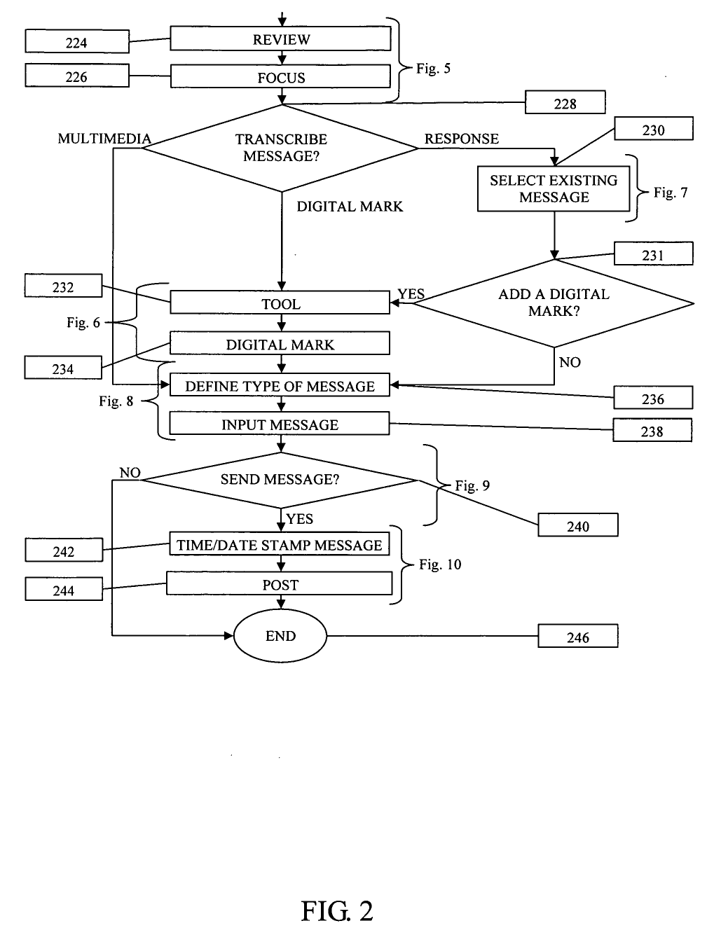

In FIG. 1, a user 102 is able to start 100 utilizing the system through a computer 106 which interacts with other computers on a network 108. The user 102 has access to a multimedia source 104 which provides various multimedia files to the system. A user 102 initiates the interactive software 107 to access the database of multimedia 148 on the network 108. A user 102 makes a determination whether or not to define the client access to the user's portion of the database of multimedia 148 which acts as a repository of a plurality of various multimedia files which the system may access. If the user 102 chooses to define the client access 109, the system grants the user 102 access to the client access 110. The client access 110 allows the user 102 to permit or deny other users access to the user's 102 database of multimedia 148. If the user 102 chooses not to define the client access 109, the available multimedia is reviewed 112, thereby to view the various multimedia files to which the user 102 has access to. The available multimedia files are grouped by user defined file properties and may be ordered in a chronological manner based upon the time and date stamps of each multimedia file thereby to create a dynamic timeline. A user may decide to add a new multimedia file 114 to the database of multimedia 148 thereby to also set file properties which issue the multimedia an assignment to ordered groups and specific timelines. The user 102 may browse 116 for a multimedia file, select 118 the multimedia file, define 120 the multimedia file thereby to provide additional information as to the type of multimedia file, provide a description of the multimedia file, assign additional file properties, and upload 122 the multimedia file to the database of multimedia 148. After the multimedia file has been uploaded to the database of multimedia 148, the uploading user 102 again reviews the available multimedia thereby to view the various multimedia files to which the user 102 has access to. The user 102 is then prompted to add new multimedia files 114. If the user chooses not to add new multimedia files, the user whom has appropriate permissible access, may review 124 the user's database of multimedia 148 and focus 126 on a specific multimedia file thereby to enhance or edit the file. In FIG. 2, the user 102 may then interact with the multimedia file and the respective timeline to consequently alert other authorized users of the system of the user's 102 interaction such that a collaborative effort may ensue between user 102 and all of the other authorized users of the system who have permissible access to the multimedia, message, and timeline on which the multimedia file resides. The user 102 may decide to create a message 228 of the user interaction whereupon the user 102 may send a multimedia message. The user 102 may define the type of message 236 the user 102 determines to input 238 into the system thereby to categorize the message for other users of the system. Alternatively, the user 102 may decide to create a digital mark message 228 of the user interaction whereupon the user 102 is able to place a digital mark 234 on the multimedia file using a tool 232 that allows for marking and designating specific aspects of the multimedia file. Lastly, the user 102 may alternatively decide to create a response message 228 whereby the user 102 selects an existing message 230 on the timeline to interact with thereby to perpetuate a response to another authorized user's timeline interaction. To additionally support the user's 102 response message, the user 102 then determines whether or not to add a digital mark 231. If the user 102 decides to add a digital mark 234 the digital mark tools 232 are displayed and the process proceeds. If the user 102 decides not to add a digital mark 231 the process proceeds. The user 102 defines the type of message 236 the user 102 determines to input 238 into the system thereby to categorize the message for other users of the system. The user 102 inputs a message 238. Once the user 102 decides to send the message 240 a time and date stamp 242 is generated, the message is posted 244 to the system and an electronic notification is sent to designated users with permissible access defined by the user 102 in the client access 110. The user 102 interaction with the timeline system is then concluded and the system processing reaches an end 246.

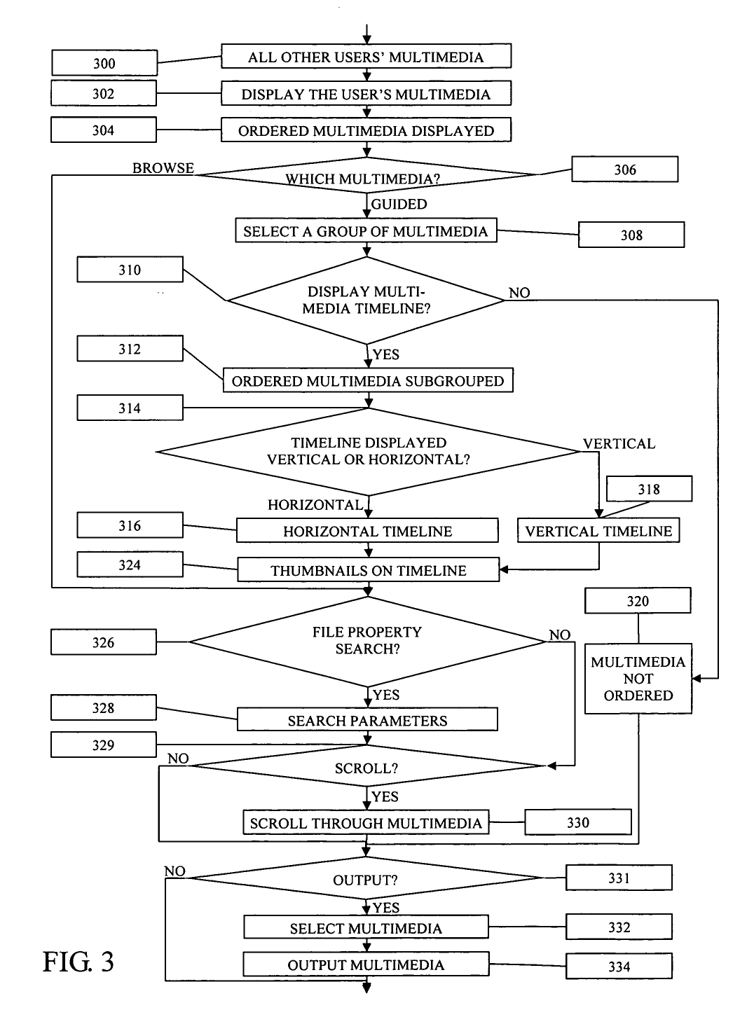

In FIG. 3, all of the groups and subgroups of multimedia, and respective timelines on the system, the user 102 has access to, are identified. A timeline is a chronological listing of multimedia files and associated messages for a specific event or project. Thus, stored, ordered multimedia files comprise a timeline. The ordered multimedia and their respective timelines which a user is permitted access to by another user are displayed 300. The ordered multimedia and respective timelines which a user has organized are displayed 302 and the multimedia is presented in a manner ordered by the group properties 304 as defined by the user who uploaded the multimedia files to the database of multimedia 148. The user determines multimedia 306 to display by either being guided through the process by the system or browsing all the available multimedia. If the user chooses to browse through the multimedia then the user inputs file property search parameters or not to 326. Alternatively, the user chooses to be guided by the system then the user selects a group of multimedia 308. The user then determines whether to display the multimedia files on a timeline in an ordered manner or not 310. If the user does not want to order the multimedia files, the multimedia files are not ordered 320. If the user does desire to display the multimedia files in an ordered manner on the timeline, the multimedia files are ordered and sub-grouped in accordance with the time/date stamp multimedia file property 312 on the timeline. The user then determines whether to display the timeline in a vertical or horizontal orientation 314 to view the timeline, whereupon if a vertical orientation is desired, the multimedia timeline is displayed in a vertical orientation 318, or alternatively, if a horizontal orientation is desired, the multimedia timeline is displayed in a horizontal orientation 316. Thumbnail images, dates, timelines, and other visual representations and combinations thereof, that are representative of the multimedia files are grouped and displayed on the timeline in a chronological order based upon the time and date file properties of the multimedia file 324. The user then determines to conduct a file property search 326, or to not conduct a specific search. If the user determines to do a search, the user enters search parameters 328. The user then determines to scroll through the multimedia 329, or to not scroll through the multimedia. If the user determines to scroll, the user is able to scroll through the multimedia 330. After the user enters search parameters 328, scrolls through the multimedia 330, or determines that the user does not want to scroll or do a search, the user then determines whether to output 331 the information. Whereupon if the user does decides to output 331 the information, the user then selects an individual multimedia file or a group of multimedia files 332. Additionally, the user may output the selected multimedia timeline, any individual multimedia file, or any selected multimedia files 334 to an output source which may be a computer monitor, a printer, or any other desired output source. If the user does not choose to output 331 the information, processing continues.

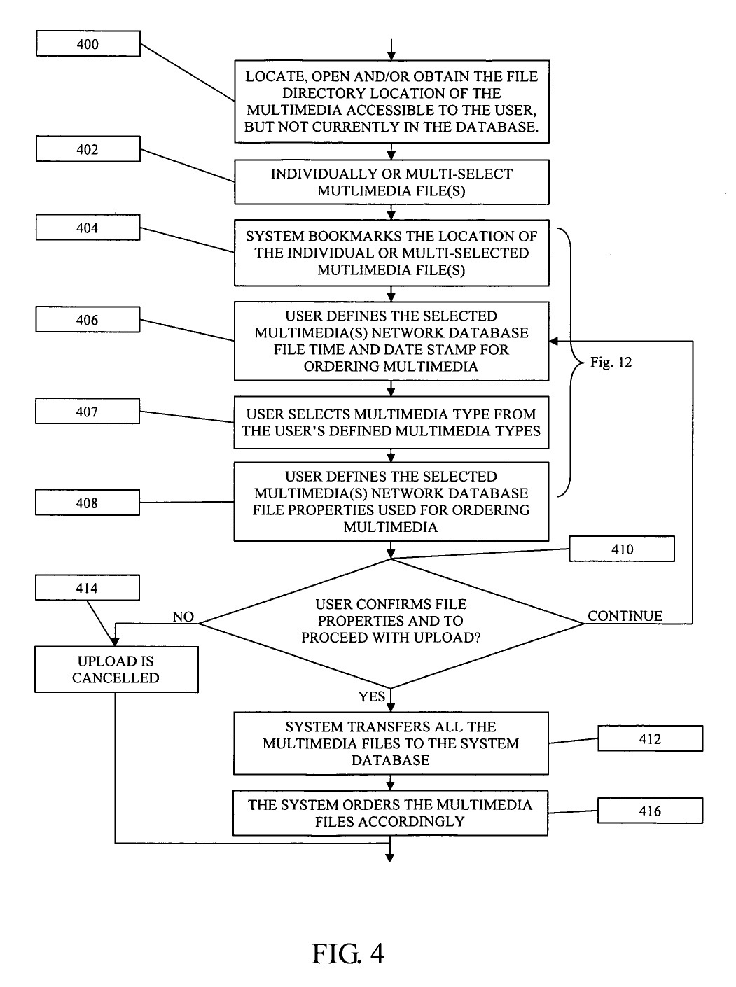

In FIG. 4, a user adds new multimedia files to the database that holds all of the multimedia files for the system. The user provides the system with the file directory location 400 of the multimedia file which the user would like to add to the system database. The user is then able to select one or more than one multimedia files 402 to upload to the database. The system then bookmarks the location of the selected individual or multiple multimedia files 404 such that the system will be able to retrieve the desired multimedia file and add it to the system database of multimedia. The user then defines the time and date stamp for the selected multimedia files 406, selects a multimedia type from the user's defined multimedia types 407, and also defines the file properties of the multimedia files 408 for purposes of ordering the multimedia files in groups and on the timelines. The user then determines whether to confirm the file properties and request to upload the files 410 to the system database of multimedia. If the user decides to cancel the upload, the uploading is cancelled 414. If the user does want to confirm the upload, the system then transfers all of the selected multimedia files to the system database of multimedia from the bookmarked locations 412 and, groups and orders the multimedia files in a chronological manner based upon the time and date stamp within the timeline to which the multimedia file was added 416.

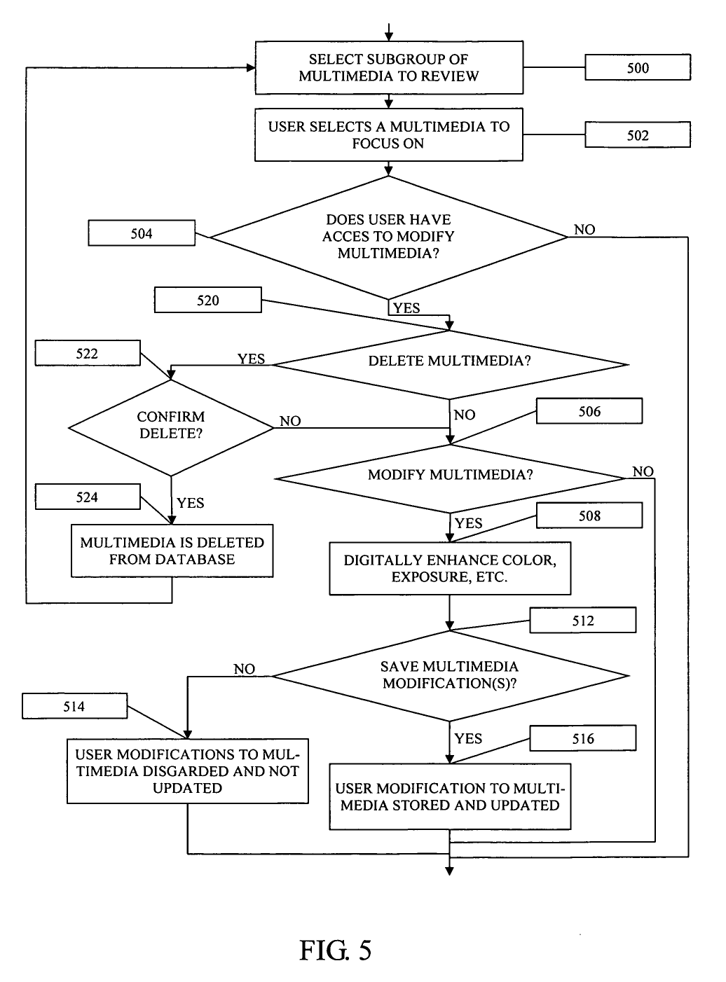

In FIG. 5 the user may delete or modify a multimedia file to enhance or improve the visual appearance of the file. The user selects a sub-group of multimedia files to review 500, whereupon the user selects a multimedia to focus on 502. The system determines whether the user has appropriate access to modify the selected multimedia file 504. If the user does not have access to modify the multimedia file, the processing continues. However, if the user does have access to modify the multimedia file, the user determines whether the user would like to delete the multimedia file 520. If the user does want to delete the multimedia file, the user determines whether to confirm the delete 522. If the user does want to delete the multimedia, the multimedia is deleted from the database 524, and the user then selects a sub-group of multimedia files to review 500. If the user does not want to confirm the delete 522, the user then determines whether to modify 506 the multimedia file. If the user does not want to modify 506 the multimedia file, processing continues. However, if the user does want to modify 506 the multimedia file, the user may digitally enhance 508 the multimedia file, and determine whether to save the multimedia modification 512. If the user determines to save the modification, the user modification to the multimedia file is stored and updated on the system 516, whereas if the user does not want to save the modification, the user modification to the multimedia file is disregarded 514.

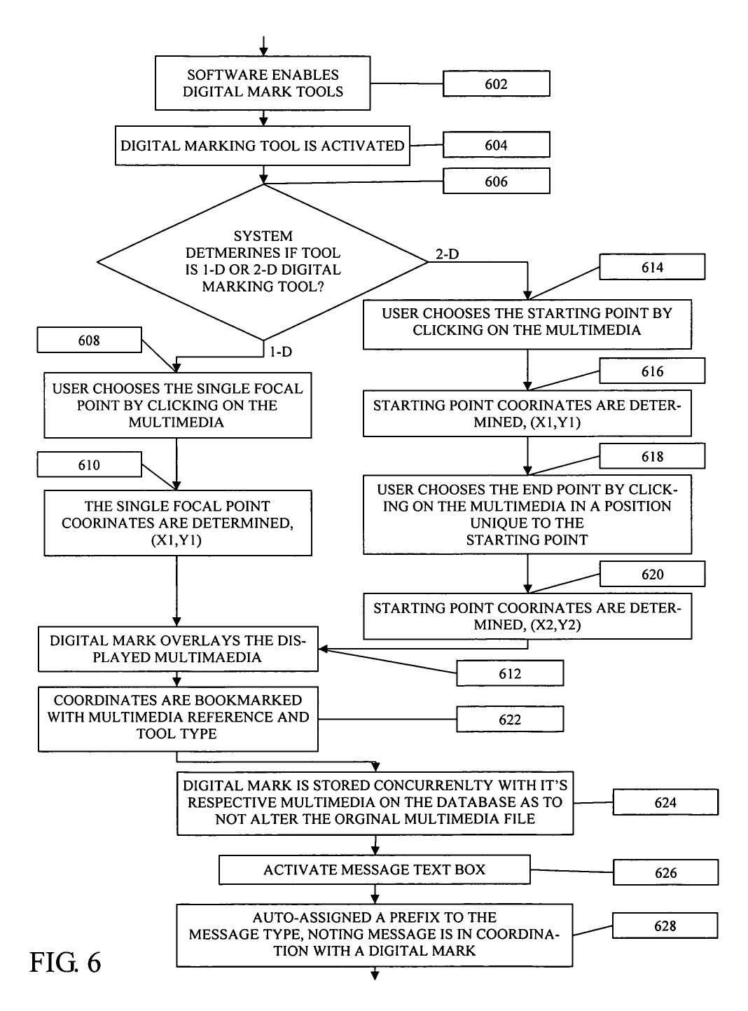

In FIG. 6, which further explains steps in FIG. 1, a user is able to add a digital mark to a multimedia file thereby to emphasize a specific area or feature of the multimedia file. The system displays the available digital mark tools 602 to the user thereby to allow the user to select the most appropriate tool to create the desired digital mark. The user activates the digital mark tool 604 in which operates in either a one dimensional or a two dimensional manner 606. If the user selects a one dimensional digital mark tool, the user chooses a single focal point by clicking on the multimedia 608 whereby the single focal point coordinates are determined 610 thereby to allow the user to designate a specific point on the multimedia file. Alternatively, if the user selects a two dimensional digital mark tool, the user chooses a starting point 614 whereupon starting point coordinates are determined 616. Additionally, the user chooses an end point 618 whereupon end point coordinates are determined 620. The digital mark then overlays the displayed multimedia 612 and the coordinates are bookmarked with an accompanying reference to the digital mark tool 622. The digital mark is then stored in the database of multimedia concurrently with the accompanying multimedia file in a manner that does not alter the multimedia file 624. A message text box is activated 626 and a prefix is auto-assigned to the message type 628 noting it as originating from a digital mark.

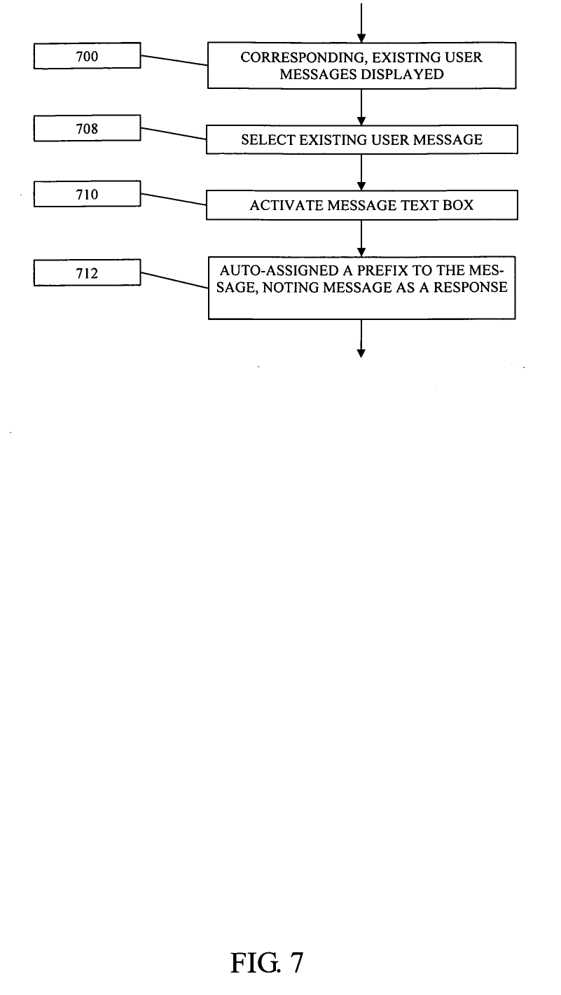

In FIG. 7, a user selects an existing user message in the system that is associated with a multimedia file in a group and on a timeline. The existing user messages are displayed 700 to the user. The user then, selects a message to respond to 708, activates a message text box 710, and then the system automatically assigns a prefix 712 to the now activated text box such that the message text that is entered will be designated as a response to the selected existing user message 708.

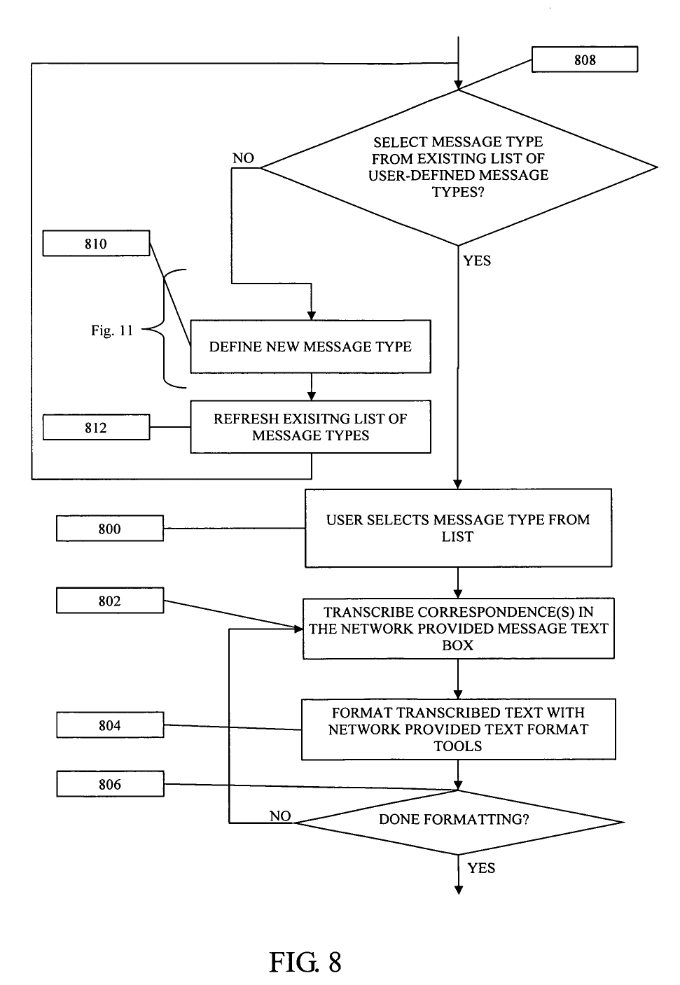

In FIG. 8, the user defines the type of message that the user wants to enter and inputs and formats the text of the message. Message types which are active bookmarks which the user can utilize to, interact with the timeline by categorizing the messages to more readily filter, output, or control access rights to users. For example, the user can associate certain messages to a user-defined message type “progress” to delineate all associated messages to message type “progress” from that of other user-defined message types during a search for all messages which the user defined as “progress.” The user decides to define the type of message which the user is going to enter by selecting a specific message type from a list of user-defined message types 808. Alternatively, the user defines a new message type 810, whereby the list of message types is refreshed 812, listing the newly updated list of message types. The user then selects the message type from the list of user-defined message types 800. The user then transcribes a textual message in a system provided text box 802 and formats the text 804 with system provided formatting tools. The user is able to continue entering text and formatting the text until the user determines that the user is done formatting 806 whereupon the user message is completed, and processing continues.

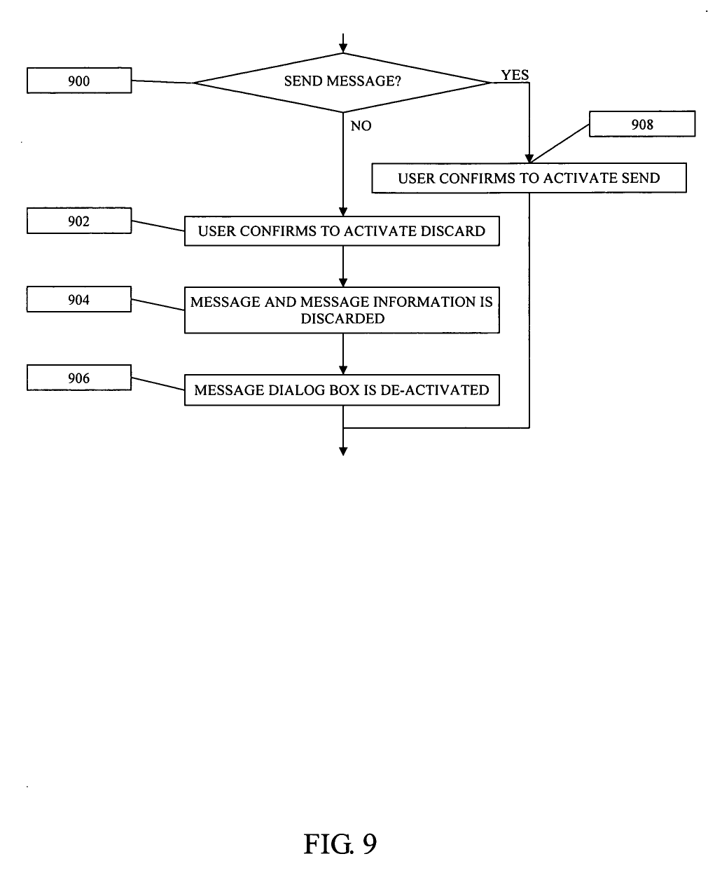

In FIG. 9, the user confirms that the user wants to send the message which the user created. If the user determines to send the message 900, the user provides a confirmation to send the message 908. However, if the user determines to not send the message, the user confirms to activate the discarding 902 of the message, the message and message information is discarded 904, and the message dialog box is deactivated 906.

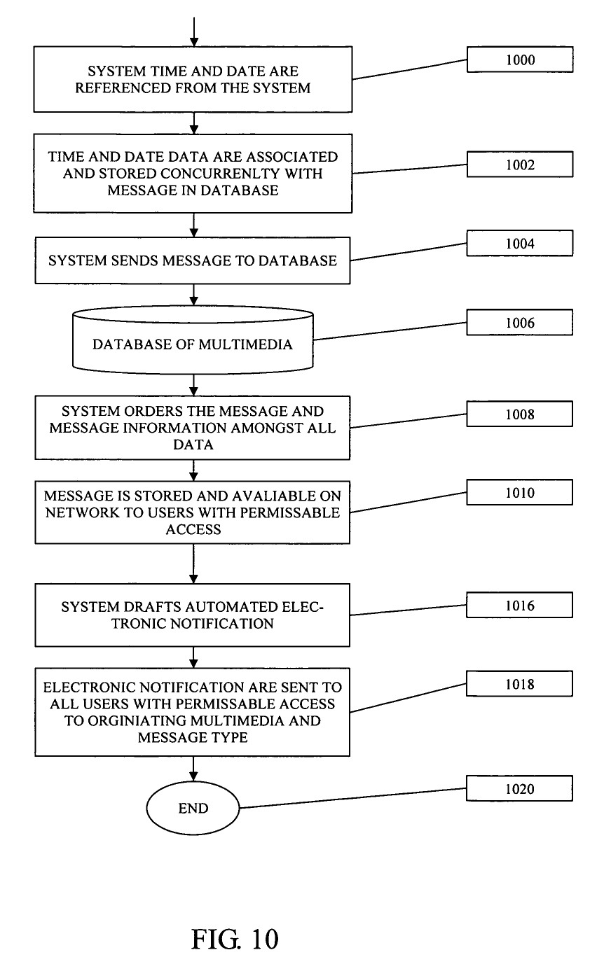

In FIG. 10, the message that a user entered in the system, the response to a message, or the interaction of a user with an accompanying message on the timeline is stored and ordered in the system with respect to a specific timeline and the system drafts and sends an electronic notification to all users who have access to the specific multimedia to which the new message applies. The time and date are determined from the system 1000 and associated with the message 1002 which is sent through the system network 1004 to the database of multimedia 1006. The message is then chronologically ordered 1008 relative to the other multimedia files and their accompanying messages of the timeline, and then stored and made available 1010 to all of the users with permissible access to the timeline multimedia files The system drafts an automated electronic notification 1016, and the electronic notification is sent by the system to all of the users with access to the multimedia timeline file 1018 to which the message relates. After the notification is sent 1018 the steps of the method and system are at an end 1020.

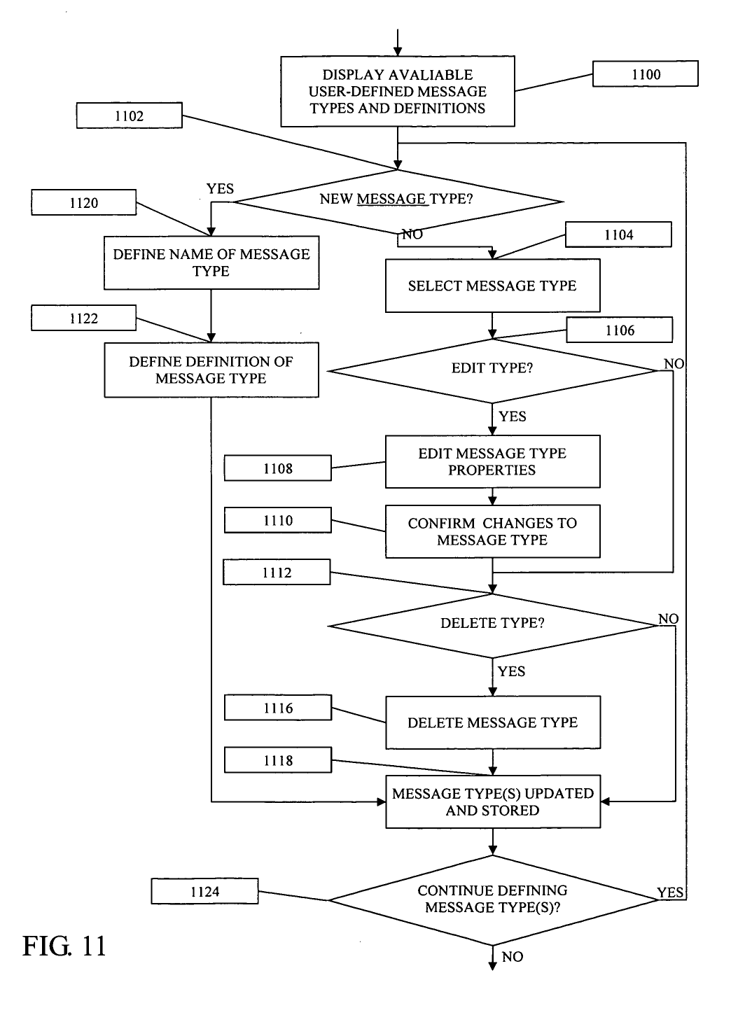

FIG. 11 further explains steps presented in FIG. 8, and displays to the user the available message types that are active bookmarks which the user can utilize to, for example, interact with the timeline by responding to another user message that has been added to the timeline, assign categories to messages, filter, output, or control access rights to users. All the available user defined message types and definitions are displayed 1100 to the user. The user then determines if the user would like to add a new message type 1102. If the user does determine to add a new message type, the user defines the name of the message type 1120 and defines the definition of the message type 1122 thereby to clarify the meaning of the type of message that has been added. If the user does not determine to add a new message type, the user selects an existing message type 1104 and determines whether to edit the type of message 1106. If the user determines to edit the message type, the user edits the message type properties 1108 and confirms the change of the message type 1110. The user then determines 1112 if the user wants to delete the message type. If the user does choose to delete the message type, the user deletes the message type 1116, and the message type is deleted from the system. The message types are then updated and all changes are stored 1118. The user then determines whether to continue defining message types 1124, whereupon if the user does not, processing continues, but if the user does want to continue defining message types, the user is prompted to then determine whether to enter a new message type 1102.

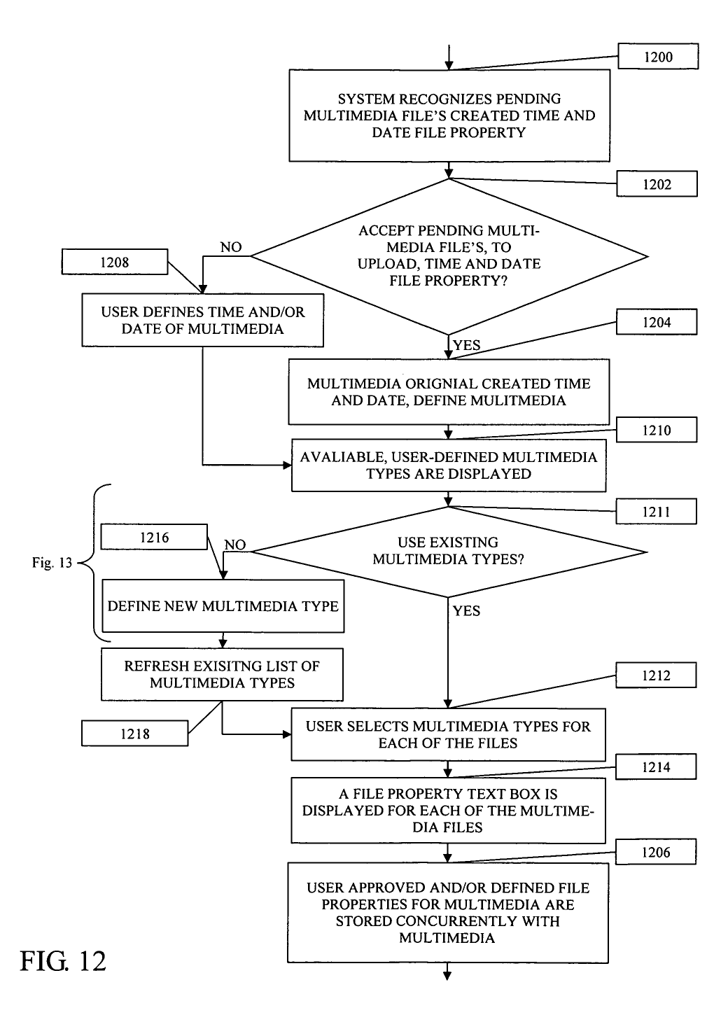

FIG. 12 further explains steps presented in FIG. 4, and allows the user to either accept a system generated time a date stamp for a multimedia file or enter a user defined time and date stamp for a multimedia file, and also define the multimedia pending upload file properties and multimedia type. When the multimedia file is to be added to the system, the system recognizes the original multimedia source creation time and date stamp of the multimedia file 1200, known as the origination time and date. The user then determines whether to accept the origination time and date stamp or to manually input a user defined time and date stamp 1202. If the user determines to accept the origination time and date stamp, the origination time and date stamp is used to define the multimedia file 1204. If the user determines not to accept the origination time and date stamp 1202, the user defines the time and date stamp 1208 for the multimedia file. The user defined multimedia types are displayed 1210. The user then chooses whether or not to use the existing multimedia types 1211, if the user chooses to use existing multimedia types, then the user selects the multimedia types for each of the files 1212. If a use decides to not use an existing multimedia type, the user then defines the new multimedia type 1216 and the list of existing multimedia types is refreshed 1218 and updated to include the new multimedia type. The user then selects the multimedia types for each of the files 1212. A text box is then displayed for each of the multimedia files 1214, and the user defines additional file properties for the multimedia. The user approved and/or defined file properties for the multimedia files are stored concurrently with the multimedia 1206.

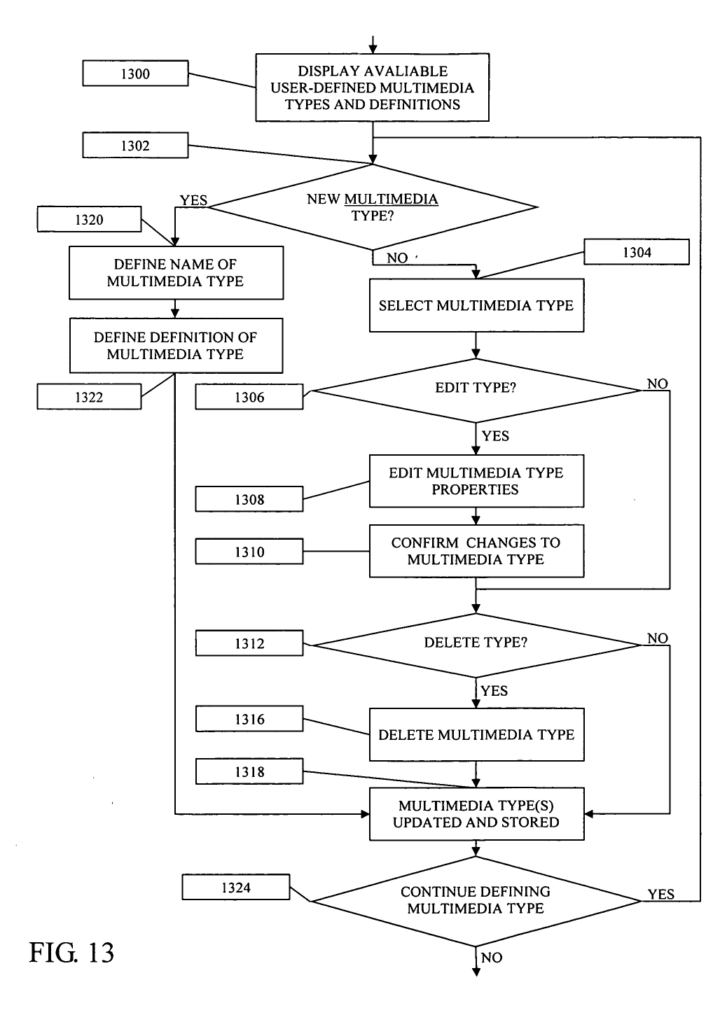

FIG. 13 further explains steps presented in FIG. 12, and displays to the user the available multimedia types which are active bookmarks which the user can utilize to, interact with the timeline by assigning categories to multimedia files to more readily filter, output, or control access rights to users. For example, the user can associate certain multimedia to a user-defined multimedia type “progress” to delineate all associated multimedia to multimedia type “progress” from that of other user-defined multimedia types during a search for all multimedia which according to the user's interpretation indicates “progress.” The system then displays the available user defined multimedia types and definitions 1300 to the user. The user then determines if the user would like to add a new multimedia type 1302. If the user does determine to add a new multimedia type, the user defines the name of the multimedia type 1320 and defines the definition of the multimedia type 1322 thereby to clarify the meaning of the type of multimedia that has been added. If the user does not determine to add a new multimedia type, the user selects an existing multimedia type 1304 and determines whether to edit the type of multimedia 1306. If the user determines to edit the multimedia type, the user edits the multimedia type properties 1308 and confirms the change of the multimedia type 1310. The user then determines 1312 if the user determines to delete the multimedia type. If the user does decide to delete the multimedia type, the user deletes the multimedia type 1316, and the multimedia type is deleted from the system. The multimedia types are then updated and all changes are stored 1318. The user then determines whether to continue defining multimedia types 1324, whereupon if the user does not, processing continues, but if the user does want to continue defining multimedia types, the user is prompted to then determine whether to enter a new multimedia type 1302.

While in accordance with the provisions of the Patent Statutes the preferred forms and embodiments of the invention have been illustrated and described, it will be apparent to those skilled in the art that various changes may be made without deviating from the inventive concepts set forth above.

What is claimed is:

1. A method for allowing a plurality of users to collaboratively interact via a dynamic timeline that presents a plurality of events in a multimedia format, the method comprising the steps of:
a) establishing a system where users, computers, networks, software, and databases interact;
b) defining access rights to said system;
c) displaying available multimedia files from said databases to said users with appropriate system access rights;
d) adding new multimedia files to said databases;
e) enhancing said multimedia files;
f) transcribing a message associated with a multimedia file; and
g) sending a notification to a user group thereby to alert said user group of said message.

2. The method of claim 1, wherein said step of displaying available multimedia files further comprises the steps of:
(1) initially displaying all of said multimedia files to which said user has system access to from said databases in an ordered manner based upon preferences of said user;
(2) selecting a group of said multimedia files from said databases;
(3) displaying said group of multimedia files in a chronological order on a timeline if said user determines to display;
(4) displaying said timeline in a vertical or a horizontal manner as determined by said user;
(5) conducting a multimedia file property search if said user determines to conduct said search;
(6) scrolling through all of said multimedia files if said user determines to scroll; and
(7) outputting selected multimedia files.

3. The method of claim 1, wherein said step of adding new multimedia files further comprises the steps of:
(1) determining a location of a multimedia file to be uploaded to said databases;
(2) selecting said multimedia file from said location;
(3) bookmarking said location of said selected multimedia file;
(4) defining a time and date stamp for said multimedia file;
(5) selecting a multimedia type for said selected multimedia file from a list of defined multimedia types;
(6) defining a selected multimedia network database file property to order said multimedia;
(7) transferring said selected multimedia file to said databases; and
(8) ordering said selected multimedia file based on said defined time and date stamp relative to other multimedia files stored on said databases.

4. The method of claim 3, wherein the step of defining a time and date stamp further comprises the steps of:
(i) recognizing a pending multimedia file original creation time and date file property;
(ii) determining to accept said pending multimedia file original creation time and date file property;
(iii) defining a user-defined time and or date stamp of said pending multimedia file if said original creation time and date file property is not accepted; and
(iv) defining said pending multimedia file with said original creation time and date file property if said original creation time and date file property is accepted.

5. The method of claim 3, wherein the step of selecting a multimedia type further comprises the steps of:
(i) displaying said user-defined multimedia types.
(ii) determining to use an existing multimedia type;
(iii) defining a new multimedia type if it is not determined to use said existing multimedia type;
(iv) refreshing an existing list of multimedia types; and
(v) selecting said multimedia type for said multimedia file.

6. The method of claim 5, wherein the step of defining a new multimedia type further comprises the steps of:
(a) displaying available user-defined multimedia types and definitions;
(b) determining to add a new multimedia type;
(c) defining a name and a definition of said new multimedia type if it is determined to add said new multimedia type;
(d) selecting a multimedia type if determined to not add said new multimedia type;
(e) editing said multimedia type and confirming changes to said multimedia type if determined to edit said multimedia type;
(f) deleting said multimedia type if determined to delete said multimedia type;
(g) updating and storing said multimedia type; and
(h) determining to continue defining said multimedia type.

7. The method of claim 3, wherein the step of defining a selected multimedia network database file property further comprises the steps of:
(i) displaying a file property text box for each of said multimedia files;
(ii) approving and defining file properties for each of said multimedia files; and
(iii) storing said file properties concurrently with said multimedia file.

8. The method of claim 1, wherein the step of enhancing said multimedia files further comprises the steps of:
(1) selecting a specific multimedia file from said databases;
(2) determining if said user has access rights to modify said selected specific multimedia file;
(3) deleting said selected specific multimedia file if said user determines to delete said selected specific multimedia file;
(4) modifying said selected specific multimedia file by enhancing the visual appearance of said selected specific multimedia file if said user determines to modify said selected specific multimedia file; and
(5) saving said modifications to said selected specific multimedia file.

9. The method of claim 1, wherein the step of transcribing a message further comprises the steps of:
(1) selecting a visual enhancement tool and placing a digital mark on a selected multimedia file;
(2) selecting an existing message to respond to; and
(3) defining a message type and inputting a textual message.

10. The method of claim 9, wherein the step of selecting a visual enhancement tool and placing a digital mark on a selected further comprises the steps of:
(i) activating a digital marking tool;
(ii) developing and placing a visual digital mark over the image of said multimedia file;
(iii) bookmarking the coordinates of said visual digital mark with said multimedia file and said digital marking tool;
(iv) storing said visual digital mark in said databases;
(v) activating a message text box to enter a description of said visual digital mark; and
(vi) automatically assigning a prefix message type for said description entered into said message text box thereby to associate said description with said visual digital mark on said multimedia file.

11. The method of claim 9, wherein the step of selecting an existing message to respond to further comprises the steps of:
(i) displaying said existing message;
(ii) selecting said existing message;
(iii) activating a message text box to enter a textual response to said existing message; and
(iv) automatically assigning a prefix message type for said textual response thereby to associate said textual response with said existing message.

12. The method of claim 9, wherein the step of defining a message type and inputting a textual message further comprises the steps of:
(i) determining to select an existing message type or to define a new message type;
(ii) defining a new message type if said user determines to define said new message type;
(iii) refreshing the an existing list of message types if said user determines to refresh said existing list;
(iv) selecting a message type from said existing list of message types; and
(v) transcribing a textual message into a text box.

13. The method of claim 12, wherein the step of defining a new message type further comprises the steps of:
(a) displaying available user-defined message types and definitions;
(b) defining a name and a definition for a new message type if said user determines to enter a new message type;
(c) editing said existing message type by editing a message type property for said message type and confirming said editing changes if said user determines to edit said existing message type;
(d) deleting said existing message type by deleting a message type for said message type if said user determines to delete said existing message type; and
(e) updating and storing said message type to said system.

14. The method of claim 1, wherein the step of sending a notification to a user group further comprises the steps of:
a) determining if said user chooses to confirm to send said notification;
b) discarding said message and de-activating said text box if said user chooses to not confirm sending of said notification;
c) obtaining time and date from said system and assigning said time and date to said message;
d) sending said message to said databases;
e) storing and ordering said message and message information relative to other database messages on said databases;
f) drafting automated electronic notification; and
g) sending said electronic notification to said users with permissible access to originating said multimedia type and said message type.

15. A computer-implemented system for allowing a plurality of users to collaboratively interact via a dynamic timeline that presents a plurality of events in a multimedia format, the computer-implemented system comprising:
a) a general purpose computing device; and
b) a computer program executable by said computing device, wherein said computing device is directed by said computer program to:
(1) establish a system where users, computers, networks, software, and databases interact;
(2) define access rights to said system;
(3) display available multimedia files from said databases to said users with appropriate system access rights;
(4) add new multimedia files to said databases;
(5) enhance said multimedia files;
(6) transcribe a message associated with a multimedia file; and
(7) send a notification to a user group thereby to alert said user group of said message.

16. The system of claim 15, wherein said computing device is directed by said computer program to perform the additional steps to display available multimedia files of:
(i) initially displaying all of said multimedia files to which said user has system access to from said databases in an ordered manner based upon preferences of said user;
(ii) selecting a group of said multimedia files from said databases;
(iii) displaying said group of multimedia files in a chronological order on a timeline if said user determines to display;
(iv) displaying said timeline in a vertical or a horizontal manner as determined by said user;
(v) conducting a multimedia file property search if said user determines to conduct said search;
(vi) scrolling through all of said multimedia files if said user determines to scroll; and
(vii) outputting selected multimedia files.

17. The system of claim 15, wherein said computing device is directed by said computer program to perform the additional steps to add new multimedia files to said databases of:
(i) determining a location of a multimedia file to be uploaded to said databases;
(ii) selecting said multimedia file from said location;
(iii) bookmarking said location of said selected multimedia file;
(iv) defining a time and date stamp for said multimedia file;
(v) selecting a multimedia type for said selected multimedia file from a list of defined multimedia types;
(vi) defining a selected multimedia network database file property to order said multimedia;
(vii) transferring said selected multimedia file to said databases; and
(viii) ordering said selected multimedia file based on said defined time and date stamp relative to other multimedia files stored on said databases.

18. The system of claim 15, wherein said computing device is directed by said computer program to perform the additional steps to enhance said multimedia files of:
(i) selecting a specific multimedia file from said databases;
(ii) determining if said user has access rights to modify said selected specific multimedia file;
(iii) deleting said selected specific multimedia file if said user determines to delete said selected specific multimedia file;
(iv) modifying said selected specific multimedia file by enhancing the visual appearance of said selected specific multimedia file if said user determines to modify said selected specific multimedia file; and
(v) saving said modifications to said selected specific multimedia file.

19. The system of claim 15, wherein said computing device is directed by said computer program to perform the additional steps to transcribe said message associated with said multimedia file of:
(i) activating a digital marking tool;
(ii) developing and placing a visual digital mark over the image of said multimedia file;
(iii) bookmarking the coordinates of said visual digital mark with said multimedia file and said digital marking tool;
(iv) storing said visual digital mark in said databases;
(v) activating a message text box to enter a description of said visual digital mark;
(vi) automatically assigning a prefix message type for said description entered into said message text box thereby to associate said description with said visual digital mark on said multimedia file;
(vii) displaying said existing message;
(viii) selecting said existing message;
(ix) activating a message text box to enter a textual response to said existing message;
(x) automatically assigning a prefix message type for said textual response thereby to associate said textual response with said existing message;
(xi) determining to select an existing message type or to define a new message type;
(xii) defining a new message type if said user determines to define said new message type;
(xiii) refreshing the an existing list of message types if said user determines to refresh said existing list;
(xiv) selecting a message type from said existing list of message types; and
(xv) transcribing a textual message into a text box.

20. The system of claim 15, wherein said computing device is directed by said computer program to perform the additional steps to send a notification to said user group thereby to alert said user group of said message of:
(i) determining if said user chooses to confirm to send said notification;
(ii) discarding said message and de-activating said text box if said user chooses to not confirm sending of said notification;
(iii) obtaining time and date from said system and assigning said time and date to said message;
(iv) sending said message to said databases;
(v) storing and ordering said message and message information relative to other database messages on said databases;
(vi) drafting automated electronic notification; and
(vii) sending said electronic notification to said users with permissible access to originating said multimedia type and said message type.
